(19) United States
(12) Patent Application Publication
(10) Pub. No.: US 2008/0138595 A1
(43) Pub. Date: Jun. 12, 2008

(54) MASS REPEATABLE THERMOFORMABLE SHEET SUCH AS WHICH MAY BE APPLIED OVER A SCRIM MATERIAL TO PRODUCE A DECORATIVE AND STRUCTURAL ARTICLE

(76) Inventor: Robert Bordener, Bloomfield Hills, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/608,336

(22) Filed: Dec. 8, 2006

(51) Int. Cl. B32B 27/00

(52) U.S. Cl. 428/220; 428/332; 428/98

(57) ABSTRACT

A structurally applicable and thermofoil incorporating article including a body having a substantially thin and planar configuration with a height, width and thickness and with a protective upper layer overlaying at least one interior layer including the thermofoil material. Colorants and additives including veining patterns and stone, glass or metal effecting granules serve to provide additional desired visual effects to the article, and which is capable of being extruded, roll or sheet formed and shipped in bulk. The article is further capable of being applied in a semi-fluidic state upon an uneven, typically male blank or scrim, and so as to anneal thereto without excessive stress accumulations.

### BACKGROUND OF THE INVENTION

1. Field of the Invention

The present invention relates generally to a thermoformable sheet. More specifically, the present invention discloses an article and associated system for producing a shallow draw, mass-repeatable thermoformable sheet, such as which is capable of being applied in a combined heat and pressure operation over a male scrim corresponding to a such as a countertop, partition and the like. The sheet may additionally employ a thermofoil or other like decorative thermoformable material, over which a protective and at least partially translucent top layer may be applied.

2. Description of the Prior Art

Thermoformed structures have been around nearly as long as plastics themselves, with many variants known in the art, the extreme breadth of which will not attempt to be listed here. Thermoplastic resins are typically thermoformed according to one of two methods. The first and oldest of these processes entailing the resultant thermoplastic formation functioning as the structure itself. This further involves applying a relatively thick structural layer of thermoplastic resin, thereby creating an expensive and heavy part. Nonetheless, this has been found to be a popular process due to relatively favorable overall economics. Thermoforming operations are successful in many applications and have recently gained competitive advantage vis-à-vis injection molded parts and cast thermoset parts, and even over some paper products.

The second process is known commercially as thermofoil. According to its most basic definition, this is an extremely thin plastic resin film that is thermoformed over a rigid substrate. This is a substantially decorative system, providing essentially no chemical resistance and a certain amount of abrasion resistance, and which provides a limited decorative monochromatic effect.

Such rigid vinyl films, commonly known as thermofoil or “RTF”, are most frequently used in cabinet doors, drawer fronts, furniture, POP and display fixtures, store fixtures, and shelving. Additional flexible vinyl films are known and which are most frequently used in cabinet surfaces, wall covering, frames, ceiling tiles, flooring, and manufactured housing. Additionally, such as exterior-grade rigid PVC films, commonly known as Profile Wrapping films are also available. These laminates are typically installed over window and door profiles, shutters, fences, and sun rooms, since they seamlessly encapsulate all outside edges and surfaces and hide minor substrate imperfections.

Thermoformers have thus far concentrated their efforts on the production of smaller parts, and further specifically on a part exhibiting a relatively small area or relatively deep draw or to create a complex or detailed shape. This last paradigm is so that the part will have the required comparative complexity and such that it would not be economically feasible in another, likely less expensive, process.

Additional larger sized parts can be produced according to such more traditional thermoforming processes and may further include, by example, such as hot tubs and shower stalls. More specifically, and if a part is simple and relatively shapeless, it often is not viable in a thermoforming process, the required materials typically being relatively thick, and engineered specifically for each specific application. In summary, such thermoforming materials and processes, as are known in the prior art, have been heretofore found to be poorly suited for commodity type applications as panels, countertops, shelves and the like.

Additional thermofoil processes, as known, involve a commodity approach to an extreme. Using PVC vinyl resins, and comprising one layer “monolith” extrusions, they are cheap and simple. Existing thermofoil processes rely on highly filled PVC resin compositions to attain the necessary thermal conductivity from the heat energy transferred through the foil, e.g. the PVC part, and to allow the immediate subsequent drawing process over such as a wood (or other rigid material) scrim. The defect in the prior art concerns all the limitations expressed heretofore and not addressed, this resulting in such thermofoils being limited in their use to nothing more than purely decorative (substantially non-functional) applications.

Another example drawn from the prior art includes Reafler, U.S. Pat. No. 4,918,800, and which teaches a continuous method for making decorative sheet materials including forming a highly reflective, specular metal layer on a continuously moving web of a thermoformable carrier film. Additional steps include in particular bending and drawing the web biaxially around first and second non-parallel cracking members to create in the metal layer a pattern of microscopic cracks which, when the sheet material is stretched and thermoformed, is capable of exhibiting a brushed metal appearance.

What is needed is a thermoformable plastic resin system that offers the financial advantages of the commodity-based thermofoil products, preferably making an economical advantage of wide sheet, universal-type construction, and one that has the engineering advantages of the more specialized thermoforming materials and processes designed for deep draw processes. Specifically, there is a long-felt need for a material that can be made into simple shapes, and most specifically made into countertops, wall panels, table tops, shelving, furniture, and other wide planar-shaped articles with shallow draws.

Further desired would be a material that is chemical, abrasion, and UV resistant. Additionally preferred would be a material which can be molded onto a male blank, rather than a female. In particular, and if the plastic material is thick and can thereby provide some protective features as desired herein, it is still further desired that the plastic veneer be able to stretch without undue stress accumulation, and as it anneals onto such as a male scrim (template).

Thus far thermoformers have, in only more limited ways, managed to employ polyolefin resins, as they are difficult to heat form. Thermofoils further are largely unfilled resins and feature essentially no engineered mineral filler content, or structural strength. Thermofoils, in particular, have not developed any kind of polyolefin chemistry. What is therefore further needed is a thermofoilable semi-structural polymer system that can bring the engineering advantages of prior thermoforming materials to a low cost system for counters and other mass-repeatable surfaces, thereby eliminating engineering for each specific application. This will also allow for an inventory storable, mass-distributable, low cost and high performance system for many building material applications.

### SUMMARY OF THE PRESENT INVENTION

The present invention provides a thermoformable sheet article (e.g. thermoplastic or potentially thermofoilable material) to be used particularly for shallow draw mass-repeatable products, such as substantially planar building items as countertops, partitions and the like. The article is constructed of a thermoformable, typically a polyolefin resin, material having a one, two or three sheet construction and which is applied in a combined heated and vacuum formed application, such as about a male scrim exhibiting a substantially planar and uniform thickness.

The present invention additionally teaches producing a polyolefin, and particularly a polypropylene article for a thermally compatible polyolefin, and particularly a polypropylene. The present invention also teaches a fine grade, highly thermally conductive filler compounded into a polypropylene sheet according to a specified thickness.

Thermal conductivity, as known, is defined as a quantity of heat which flows, in one second, though a material sample exhibiting a surface area of one meter squared and a thickness of one meter, if the temperatures of the two end surfaces of the sample differ by 1 K (2/(m·k)). For example, known ratings of thermal conductivity include 0.58 (for sand, quartz (dry)), 9.9 (pure quartz), and 0.35 (mica), it being further understood that any desired conductivity profile can be achieved by blending of various silicates or other materials, particularly aluminum or other metals.

A material's linear thermal expansion coefficient (CLTE) is further defined as the relation in the change in temperature of to the change in a material's linear dimensions. By mathematical representation, such change is measured in terms of (α in 10-6/K at 20° C.) or, more generally, by ASTM D696 in/in/° F. A selected rating for polypropylene copolymer is 4.30×10⁻⁵° F. Another objective of the present invention is to provide a polypropylene material exhibiting a process-capable CLTE, potentially even matching or bettering that of a PVC material.

The material is typically formed in a substantially planar configuration, typically in sheet form with a thickness ranging between 8 to 40 mils, and may include at least a protective upper layer and at least one or more decoratively effecting or structural supporting interior layers. In a preferred embodiment, the upper layer is most preferably produced from a highly crystallized polypropylene (e.g. homopolymer) or polyethylene material, and which may contain decorative effects, such as further including a low intensity mixing process to mimic a marble veined pattern or a decorative granule disposed therein to simulate any other stone, metallic or a translucent color with visible rearward color surfaces so as to effect a glass like appearance.

A thermofoil material may further be incorporated into an interior and visually accessible layer of the article material, and such that the thermofoil layer provides a decorative inner material in cooperation with a clear protective outer and wear layer. Alternatively the article may incorporate a similar hardened and highly mineral filled polypropylene, or PVC resin interior layer co-extruded or co-laminated into a single structure this also capable of being modified with additives and such that it exhibits a desired modulus of elasticity, cross-linking, opacity, and the like. The article may again further be comprised of a single layer or may exhibit multiple layers within the scope of invention.

A plurality of granules may be entrained within at least the outer layer of the material article, the granules each having a specified size and being selected from a group exhibiting at least one of metallic, stone and silicate/glass effects. The article body may further exhibit at least one non-planar arcuate extending edge, the granules exhibiting at least one of a controlled fracturing and segmenting effect at a region proximate the non-planar edge, this enabled by the decorative granules exhibiting a sufficient modulus of elasticity to permit substantially non-segmenting bending of the granules and during formation about a non-planar scrim surface. Further still, the granules may be designed, sized and graded such that they correspond in their largest portion of planar dimension of the granulate size distribution to less than 30° included angle of the radius of the arcuate edges of the article being made. This last design is particularly to employ the use of jagged-edged and substantially irregular-shaped granules.

The present invention further contemplates the application of more conventional thermoforming processes in the creation of a thermoformable/thermofoil article. These may also include a non-linear application by which a more subtle thinning of the overlapping high aspect ratios is caused by stretching of the thermoformed sheet, such as forming the same about an irregular corner of a substrate scrim or other rigid article or mold surface.

The ability to create an article exhibiting such as an 8-50 mil overall thickness, such further exhibiting overlapping high aspect granules in multiple layers, will result in a substantially imperceptible loss of visual effect resulting from subtle thinning of these high aspect ratios. In one example, a thinning of such granules, downward to 2-3 substantially overlapping layers from such as an initial 4-5 overlapping granule layer configuration associated with an initially formed thermoplastic sheet, will exhibit no substantial loss of visual perception along a non-continuous thermoformed zone.

### BRIEF DESCRIPTION OF THE DRAWINGS

Reference will now be made to the attached drawings, when read in cooperation with the following detailed description, wherein like reference numerals refer to like parts throughout the several views, and in which:

FIG. 1 is a perspective view of an exemplary thermoformed article formed according to the various processes according to the present invention;

FIG. 2 is an end plan environmental view illustrating the nature in which a thermoformable article is applied about a male scrim in a combined vacuum formed and heated fashion and according to one preferred embodiment of the present invention;

FIG. 3 illustrates a perspective view of the heat and vacuum forming process of FIG. 2;

FIG. 3A is a side view illustration of vacuum forming process also shown in FIG. 2 and with the thin resin sheet in a substantially drawn position about the male scrim;

FIG. 3B is a succeeding and inverted perspective illustration of the resin sheet formed about the scrim;

FIGS. 3C-3E illustrate in diagrammatic fashion successive vacuum forming stages, similar to those previously discussed in reference to FIGS. 2, 3, 3A and 3B, and showing a protocol of steps including, respectively, heating a thin plastic sheet, lowering an associated clamping frame and drawing a vacuum underneath the table to form the part;

FIG. 4 is a perspective illustration of a two layer thermoformable sheet article, of exaggerated thickness, and illustrating a top layer decorative effecting layer;

FIG. 5 is an sectional cutaway perspective of a further selected thermoformed sheet article produced according to the present invention and illustrating a clear top coat layer overlaying an interior layer of a thermofoil material, this applied over a rigid substrate backing;

FIG. 6 is a perspective view of a further selected article produced according to the present invention and illustrating an arcuate rounded edge with non-segmented decorative granules;

FIG. 7 is an enlarged side cutaway view as referenced at 7-7 in FIG. 6 and illustrating the non-segmenting fashion of the decorative granules associated with a substratum layer, in combination with a multi-layer article construction;

FIG. 8 is a sectional perspective of a further example of a flexible and thermofoilable article incorporating a veined decorative pattern into an upper layer;

FIG. 9 is a diagram illustrating a series of process steps for creating an article according to the present invention;

FIG. 10 is a side view illustrating a thermoforming operation wherein a thermoplastic sheet exhibiting multiple overlapping layers of high aspect granules is wrapped about a male scrim; and

FIG. 11 is a partial enlarged view illustrating a substantially imperceptible thinning of the high aspect and multiple layer overlapping granules along the zone of non-linear thermoforming and according to the present invention.

### DETAILED DESCRIPTION OF THE PREFERRED EMBODIMENTS

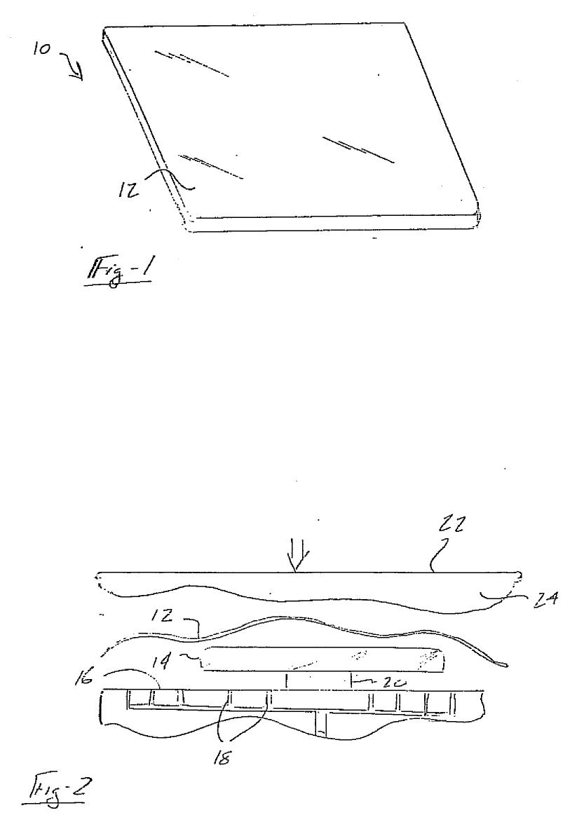

Referring to FIG. 1, a three-dimensional article is generally illustrated at 10 according to the present invention. The article 10 illustrated is generally understood to be a countertop article, however the present invention is also suitable for applying to any of range of shallow draft and mass repeatable articles, such as also including panels, shower stalls, or the like.

As previously described, the present invention discloses an improved thermoformable sheet 12, such as exhibiting a thickness in a range of between 8-40 mils (i.e. 0.008″-0.040″ making it about half as thick as a thermoform and about two to three times as thick as conventional thermofoil sheeting known in the art, this creating a true “in between” and unique material dimension), and having either a single, double or triple layers, and which may further incorporate an interiorly disposed thermofoil layer or other similar sheet material. The sheet 12, as will also be discussed in additional detail according to further variants, exhibits a protective top coat layer and possibly one or more structurally and/or decoratively contributing backer layers in order to provide an article exhibiting desired decorative and functional considerations.

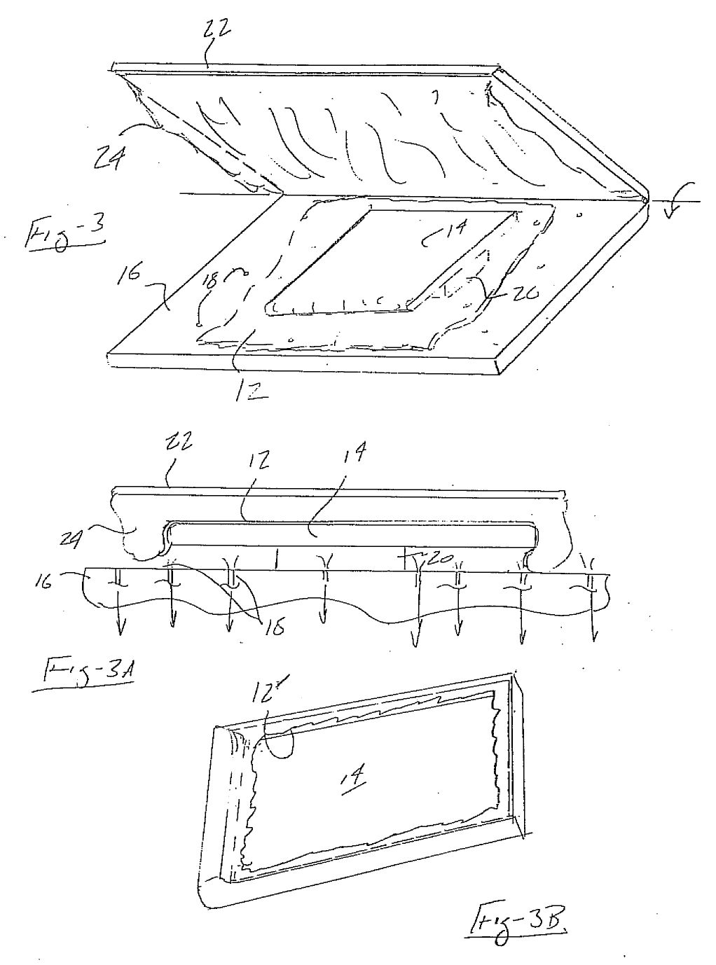

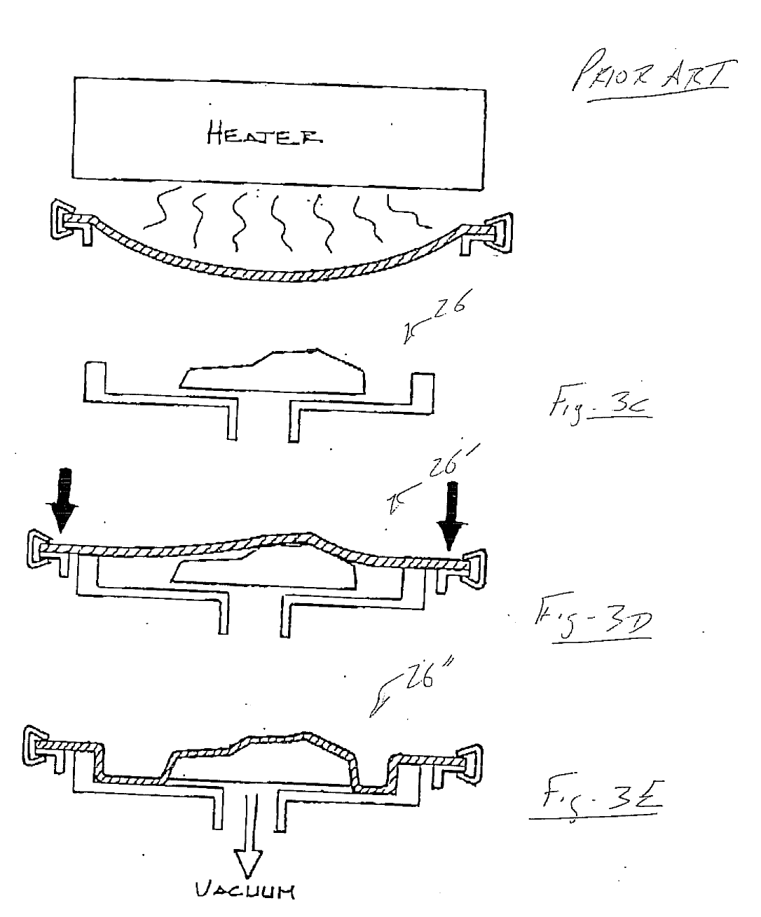

As will be further described in detail, the sheet 12 is applied, typically in wraparound fashion according to a combined heat and vacuum pressure drawing process, about a male scrim 14, see in FIG. 2 as well as in each of FIGS. 3, 3A and 3B. The scrim 14 is defined to include any rigid substrate material having a substantially planar and uniform thickness, such as a particle board or other material, and which may further include a non-continuous underside lip or projection about which the thermoformed sheet is applied and from which a resultant trailing edge may be trimmed.

As previously described, the material of the present invention is preferably constructed of a polyolefin or like polymer material and further preferred to be multi-layer in composition. Although a single layer can be employed, a preferred variant includes at least two layers preferred. In the event a single layer is used, some combination of durability, cost advantages and aesthetic advantages may be sacrificed. Nonetheless, the present invention is economically viable with a single layer. In the event two layers are employed, a decorative upper layer is preferably at least partially translucent, although further variants contemplate that the upper layer is capable of being substantially, or even fully, opaque, given the sacrifice of certain visual advantages to the resultant product.

Referring to FIG. 2, a plan view is shown of an associated heat and vacuum forming process for creating the article such as illustrated in FIG. 1, and by which the thin resin sheet 12 is illustrated in a pre-formed position about a male scrim 14. As will be subsequently described in additional detail throughout the several succeeding illustrations in FIGS. 3-3E, a vacuum forming sandwich mold may include a table top surface 16 upon which the scrim 14 is positioned, above one or more vacuum holes 16, and in an elevated or stand-off fashion by such as a platform or support 20.

The thermoplastic sheet is represented at 12 as a heated semi-molten article which is prepositioned above the scrim 14 and prior to downward engagement of a lid 22. An opposing underside of the lid 22 exhibits a flexible, airtight and downwardly pressing membrane 24, this acting to apply downwardly against the top surface of the heated sheet 12, in cooperation with a vacuum induced through the underside of the scrim 14, and through the evacuation holes 18, thereby creating the scrim wrapped article.

As will be further described in reference to the associated method, any of a number of forming operations can be employed for successively drawing the thermoformable sheet in wraparound fashion about the male scrim, these primarily again including such as a combined heat and vacuum forming process, but also understood to include such additional options as extrusion, colamination or other like application processes. As this is not a primer for heat-forming operations, the intent and processes will be clear to those skilled in art. The sheet thickness (e.g. again typically 0.008″ to 0.40″) is, in one preferred embodiment, typically less than 1/10 of the least planar dimension of the scrim 14. Additional desired variants contemplate a two layer resin sheet exhibiting a thickness range of 0.003″ to 0.008″, provided in a single color and including such as a polypropylene filled to exhibit a controlled coefficient of thermal expansion (CLTE) of approximately 2×10⁻⁵° F. A further desired variant may include a two layer applied article including an entrained granule package emulating a stone, metal or glass top color effect.

Referring further to FIG. 3, a succeeding perspective illustration is shown of the resin sheet 12, illustrated in substantially phantom fashion, in an intermediate forming stage about the scrim 14. The configuration of the sheet in FIG. 3 is again understood to represent one selected process for heat/vacuum thermoforming a resin sheet 12 against a rigid substratum article 14, other possible processes also including such as extrusion, colamination or other like process which results in the sheet 12 being drawn against or otherwise applied in a heated condition to a rigid substrate article.

FIG. 3A further shows a side view illustration of vacuum forming process also shown in FIG. 2 and with the thin resin sheet 12 in a substantially drawn position about the male scrim 14. Referring further to FIG. 3B, a succeeding and inverted perspective illustration of the resin sheet is illustrated in formed fashion about the scrim 14 and in particular showing a remaining ragged inner edge 12′ of the vacuum formed sheet which is capable of being trimmed, such as by a knife or other process cutting tool.

FIGS. 3C-3E illustrate in diagrammatic fashion, see at 26, 26′ and 26″ respectively, successive vacuum forming stages, known in the relevant art, and similar to those previously discussed in reference to FIGS. 2, 3, 3A and 3B, showing a protocol of steps for defining the vacuum formed resin article. These steps again include, respectively, heating a thin plastic sheet 26 (as in FIG. 3C), lowering an associated clamping frame (at 26′ in FIG. 3D) and drawing a vacuum underneath the table (26″ in FIG. 3E) to form the part. Reference is again made to the illustrations of FIG. 2 and FIGS. 3-3A which illustrate related structural applications of a vacuum forming process.

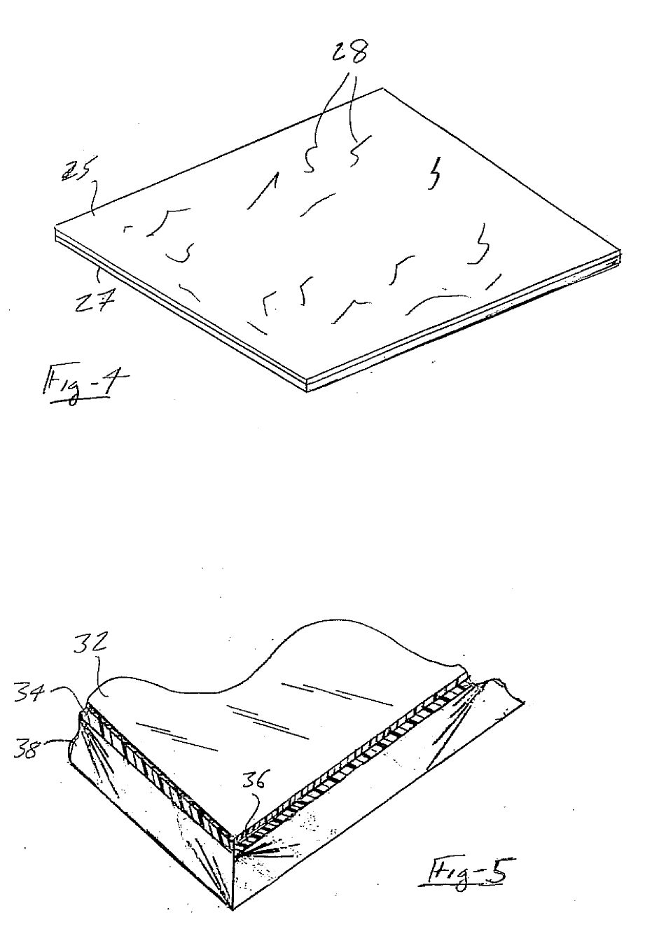

Referring further to FIG. 4, a perspective view is shown of a dual layer sheet and which includes an upper or top coat layer 25 and a lower or backer layer 27. As previously explained, the backer layer 27 can be secured to a rigid substrate, such as previously illustrated as a particleboard material 14, but which may also include a low grade polymer backing or other suitable and durable substrate material.

As further previously described, the backer layer 27 can be provided as a rigid vinyl film (e.g. thermofoil or “RTF”), a flexible vinyl film or, in certain instances, an exterior-grade rigid PVC film. Without limitation, the thermofile material can be substituted by a foilable markerboard or suitable and similarly configured thermoform material (e.g. again a polyolefin) within the scope of the invention.

The upper resin layer 24 is preferably a highly crystallized polypropylene or polyethylene and which may contain certain decorative effects. These may further include a low intensity mixing process utilizing a decorative liquid additive, and in order to simulate a marble veined pattern, see for example as referenced at 28 in the each of FIGS. 4 and 8.

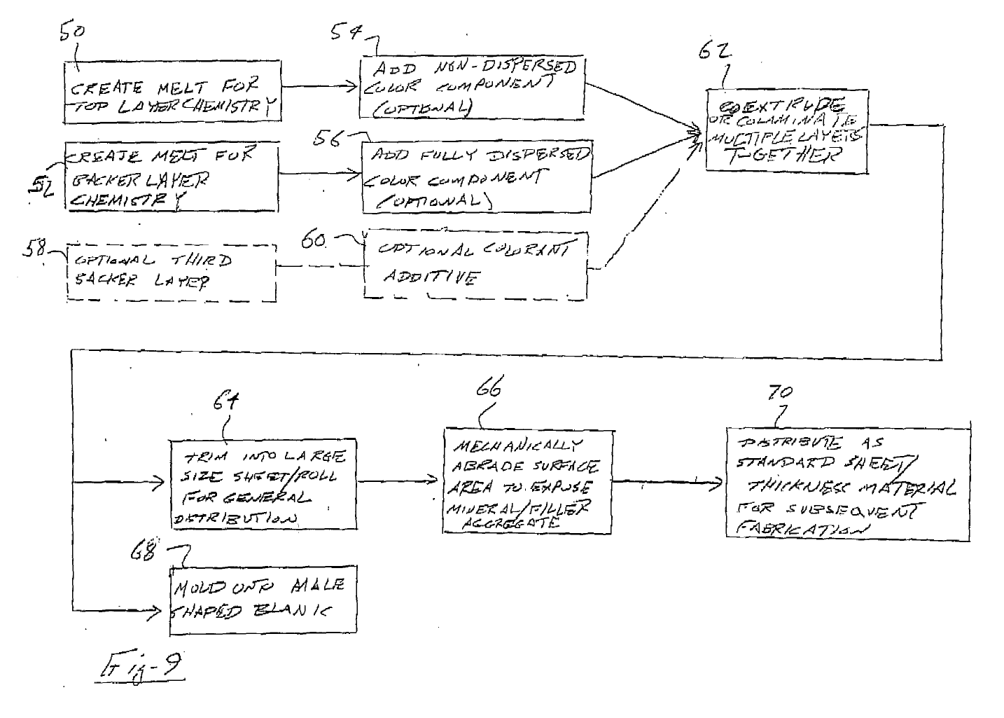

Alternatively or additionally, pluralities of decorative granules, see at 30 in the subsequent variant of FIGS. 6 and 7, may be disposed or otherwise entrained within either the top or, as illustrated, the backer layer of an associated two-layer sheet to simulate granite or other faux granite surfaces. Especially contemplated is the use of an inventive and high aspect ratio granule (i.e. a granule having a much greater length and/or width as opposed to its thickness), this in order to create an inventive metallic pigment granule to create a powdered metal finish, a speckled quasi-solid appearance, a multi-toned highly translucent colored appearance greatly simulative of “art glass”, and solid colors.

When utilizing a backer layer 27 to impart color in visually exhibiting fashion through the upper layer 24, an additional variant contemplates the addition of a dispersion dye (e.g. further such as a small amount of pigment additive) to the upper layer and in order to impart a further slight color effect. In the instance of a two-layered embodiment, the upper decorative layer 24 may be filled with fine index-of-refraction-matching crushed mineral. In a preferred variant, the mineral may include a silaceous or calcined material, in one embodiment less than 3,000 nm in diameter, aqueous-based, and less than 1,000 nm in mean diameter as a reclaimed post industrial waste material. The mineral material is ideally leaded into the decorative layer at about 10-30% by weight, and blended into this layer are the decorative effect materials, UV stabilizers and epoxoid binders, and stress relievers such as microscopic rubbers.

The upper decorative layer 25 is ideally made from a highly crystalline, highly translucent polypropylene. As further illustrated in the perspective of FIG. 5, the thermoformed sheet may have a substantially clear protective top layer, see as shown at 32, especially if this layer is a non-porous acrylic or polyester, such a top layer typically exhibiting a thickness of between 0.001″ to 0.010″ in thickness and exhibiting a high gloss.

The function of the back layer, as also shown at 34 in FIG. 5, is to provide structural thickness and opacity, in one desired application so as to block light transmission from 180°relative to the viewable surface of the sheet. These functions may be split into two subdivisions of the backer layer 34, e.g. by the coextrusion or other thermoforming of additional backing layers.

According to certain variants, the desired opacity may optionally be supplied by a film applied at the upper border of the backer layer (see as representatively shown at 36 in FIG. 5), underneath of which may be situated the structural substrate layer 34, and which in this instance exhibits reduced aesthetic property requirements since it is not visible from the viewable surface. This layer is preferably filled with talc and/or calcium carbonate to lower cost, increase density and ease general material handling.

In a preferred application, the sheet is filled within at least one layer with a mineral exhibiting a sufficiently high thermal conductivity, as previously defined, to facilitate heat transfer during at least one of the forming and curing processes. The construction then may be applied to such as a rigid substratum or male scrim material, such as which is again representatively shown in FIGS. 5 and 38.

As previously described, thermal conductivity, as known, is defined as a quantity of heat which flows, in one second, through a material sample exhibiting a surface area of one meter squared and a thickness of one meter, if the temperatures of the two end surfaces of the sample differ by 1 K (2/(m·k)). For example, known ratings of thermal conductivity include 0.58 (for sand, quartz (dry)), 9.9 (pure quartz), and 0.35 (Mica), it being further understood that any desired conductivity profile can be achieved by blending of various silicates or other materials, particularly aluminum or other metals.

According to a further preferred variant, the filler material employed is a silaceous material, typically either an aqueous, substantially spherical, or high aspect ratio silica, with a further desired bonding or coupling agent incorporated therein. Additional variants contemplate a modified polypropylene resins (PP) exhibiting a coefficient of linear thermal expansion (CLTE) similar to that of a filled polyvinyl chloride (PVC).

A material's linear thermal expansion coefficient (CLTE) is further defined as the relation in the change in temperature of to the change in a material's linear dimensions. By mathematical representation, such change is measured in terms of (α in 10-6/K at 20° C.) or, more generally, by ASTM D696 in/in/° F. Along these lines, a selected rating for polypropylene copolymer is 4.30×10⁻⁵ mm/mm/° C.

One objective of the present invention is to provide a polypropylene material exhibiting a CLTE comparative to that of a PVC material. And further contemplates producing a polyolefin (e.g. propylene) material, loaded with a mineral and in order to exhibit a CLTE less than 7×10⁻⁵° C. The polyolefin material may further be modified with thermal conductive additives, e.g. such as to modify its thermal conductivity characteristics (0.35 or higher), and may further contemplate being incorporated within a composite. The polyolefin material may further be thermally expanded within the forming/curing web of material (e.g. such as may be provided in roll stock form) according to a desired temperature and line speed profile, such as further in order to establish a desired orientation (e.g. less than 50%) relative to both linear and cross speed directions.

Additional considerations include orientation of a polymer component within the polyolefin material in both linear (machine) and crosswise directions of less than 50% according to one variant. At least one thermally conductive additive can further be incorporated into the polyolefin material, such mineral featuring a thermal conductivity greater than 0.35.

Referring to FIGS. 6-8, a further example is shown at 40 of an article exhibiting at least one non-planar arcuate extending edge. The article may otherwise be similar in construction to that previously described with a top layer 42, an intermediate layer 44, such as incorporating a plurality of the decorative granules 30, a first backer layer 46 and an optional substratum layer 48 (generally referenced in FIG. 7 and not necessarily a part of the article but including also a rigid material to which the article can be secured, such as again in the form of a male substructure or scrim).

The granules 30 as shown exhibit at least one of a controlled fracturing and segmenting effect at a region proximate said non-planar edge and upon bending of the article, such as which may be applied in a semi-fluidic/formed state over the backer material 46 and prior to annealing. The decorative granules 30 may have a specified shape and size, and further such that they exhibit a sufficient modulus of elasticity to permit substantially non-segmenting bending during formation about the non-planar edge. In one preferred embodiment, such non-segmenting bending or subsequent potential tearing of the thermofoil structure is avoided by use of a flexible granule such that the granule has less rigidity in heat process than the foil itself as defined by the fact that the foil wraps smoothly around desired curves to make the desired part and the granule remains in situ with the foil during and after forming. As further again shown in FIG. 8, a decorative veining effect (see again at 28) may also be combined with the non-linear forming of the thermofoil article (as well as with or without additional surface applied crushed minerals or additional decorative granules) within the scope of the invention.

A further variant of a polymer sheet includes providing a translucent polymeric matrix formed into a suitable sheet and defining an outer face and a backing surface. As with previous variants, the sheet further exhibits a thickness no greater than 10% of a least planar dimension associated with an article about which said sheet is secured.

The sheet incorporates at least one visible and decorative granule component larger than 0.004″ and smaller than 0.6″ in planar size, the granules being present across at least 10% of a total visible surface area of the sheet. A further decorative component is incorporated within the sheet and selected from at least one of a pigment, a dye, and a dispersion dye. In order to maximize an overall visual and decorative effect of an article created, the first decorative component varies from the second decorative component.

Additional features include the sheet having a specified shape and size and further including the granules being distributed across more than one individual strata layer associated with a multi-layer structure. In a further preferred application, the sheet may include at least three layers incorporating individual pluralities of said granules, such as in overlapping and individual layers, and which are collectively visible across at least 20% of a total planar surface area of said sheet.

The decorative granular component includes at least one of a cleaved mineral particulate, a shredded plastic film, and a biopolymer particulate. The pigment or dye based decorative component may further be embedded within one or more individual decorative granular components.

As with previously described embodiments, the polymeric matrix has a thickness of between 0.01 and 0.10 inches and may also include a granular coating applied intermediate between the polymeric matrix and a first selected granular entrained strata layer. A back zone may be secured to a backing surface associated with the matrix defined sheet and an adhesive secured intermediate between the back zone and the article about which the sheet is secured. The adhesive is typically transparent (so as not to be visible through the sheet). Also, a surface protective layer may be applied to the viewable surface area of the sheet.

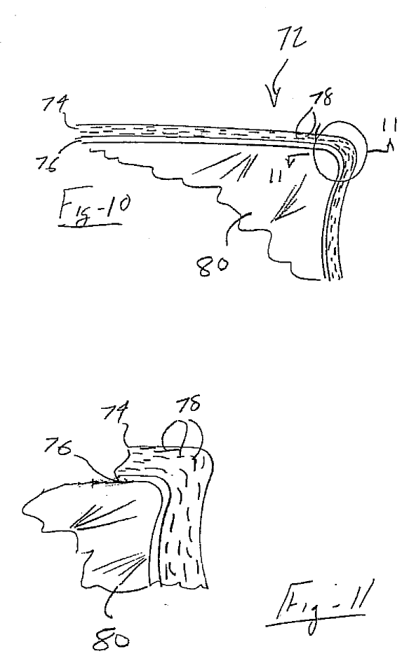

Referring now to FIG. 9, an associated process for forming the sheet of the present invention is disclosed and contemplates a twofold procedure, including the manufacture of the sheet itself and the manufacture of a commodity planar article (e.g. rigid male backing material, other scrim material or the like) for use with the sheet. The present invention further contemplates a unique business model is apparent by creating a commodity repeatable low cost heat-formed method incorporating both the article and associated method of the present invention.

The process steps include creating a melt for the top layer chemistry (see at 50) and contemporaneously creating a melt for a backer layer chemistry (at 52). The chemistries preferably may further include a non-dispersed color component incorporated into the top layer (at 54) as well as a fully dispersed component in at least one sub layer (at 56). One or more additional layers, see as generally represented at 58, may be provided and which may further include an additional and optional colorant additive 60 in order to impart a desired visual effect to the resultant product

The individual layers are applied together, such as by coextruding or colaminating or otherwise together, see at 62, this in particular being the desired process in instances where the resultant top layer is the thickest. The resultant formed article is then trimmed into large, typically standard size, sheets (see at 64) for general distribution as a universal building material. Depending upon certain factors, including the use of a rigid or flexible vinyl (thermofoil) film, the article may either be produced as standard (stackable) sheets or, alternatively, as a flexible and rollable material.

Additional steps include mechanically abrading a surface area of the sheet (see at 66) and in order to expose a mineral filler/aggregate associated with its upper surface to provide a more realistic appearance. As further previously described, the coextruded article may alternatively be molded onto a male shaped blank (see as generally represented at 68 and corresponding to the description of FIGS. 3A-3C), either prior or subsequent to the steps identified at 64 and 66, this prior to annealing and forming thereto and in order to create such a rigid article as a countertop, backsplash, shower stall or the like.

Yet additional features, specifically drawn to the business article of the invention, include the ability to distribute the resultant bulk article to fabricators according to standardized dimensions (length, width and thickness), see finally step 70. Accordingly, a fabricator may enjoy reduced inventory cost/complexity in stocking the article in bulk form. Further, any trained fabricator can make any of a list of part types, utilizing the same sheet and equipment and unlike current thermoforming in which each part is required to be engineered specifically.

Further material and process variants are provided by unique decorative effects in-situ in the decorative layer. These include overlapping visibly differentiable granules within a narrow strata. Such decorative strata is ideally less than 030″ thick and further preferred to be between 0.006″ and 0.018″ thick. Additionally, a rear facing primer may be co-laminated, painted, sprayed, co-extruded or planarly bonded along the rearmost surface of the foil structure so as to allow use of common foil process adhesives and/or the rearmost layer can function either in whole or in part as an adhesive.

Movement of a part during heat forming has thus far precluded every attempt at a thermoformable process of any kind to have granules therein that can simulate stone or other Corian® like articles. The problem has been particle migration wherein the granules “spread out” at draw areas of the thermoform, and thusly telegraph the formation of the sheet. Further, granules tend to create stress centers that create origins for tearing and deformation of the sheet during heat processing.

The solution has been found to include overlapping flattened (plate like) granules with a relatively high aspect ratio, preferably above 8 (defined as the longer of a width or length relative to its thickness) and a planar size of at least 0.03″ to 0.2″ for the larger granule sizes (reference again is generally made to the granules 30 shown in FIG. 7 and intended to show but one potential arrangement of high aspect and overlapping granules entrained within an associated single/multiple thermoformed sheet material).

In such a process, it is contemplated that the granules change at least one of their size, color, hue, or shape during processing and in order to create a desired variegated effect. By overlapping the decorative effect, it is not visibly changed to most observers (e.g. the end user usually cannot tell the difference), when the granules spread apart, and as more granules “underneath” are exposed in this process.

FIG. 10 illustrates at 72 a side view of a thermoforming operation, in this instance exhibiting a thermoplastic sheet according to any of the previous constructions and exhibiting dual layers 74 and 76. In the instance of an upper, high aspect granule entrained layer (e.g. again at 74), is again exhibits multiple overlapping layers of high aspect granules, see as generally shown at 78.

A shortcoming noted in prior art examples of thermoformed sheet also includes the tendency of dispersed, lesser aspect ratio, granules to “thin” at a selected zone of a non-linear bending or wrapping, and such as about rounded or angled edges of an associated male substrate/scrim, see further at 80. The result if the creation of a visually perceptible bend line or zone, and whereby the decorative effect provided by the granules is compromised.

FIG. 11 is a partial enlarged view of the zone indicated at 11-11 in FIG. 10, and which illustrates a substantially imperceptible thinning of the plurality of high aspect and multiple layer overlapping granules 78 along the indicated zone of non-linear thermoforming (i.e. an irregular edge location associated with the scrim 80). The present invention contemplates the application of more conventional thermoforming processes in the creation of a thermoformable/thermofoil article, and which may include a non-linear application by which a more subtle thinning of the overlapping high aspect ratios is caused by stretching of the thermoformed sheet, such as forming the same about an irregular corner of a substrate scrim or other rigid article.

The ability to create an article exhibiting such as an 8-50 mil overall thickness, such further exhibiting overlapping high aspect granules in multiple layers, results in a substantially imperceptible loss of visual effect resulting from subtle thinning of these high aspect ratios. In one example, reference being again made to FIG. 11, a thinning of such granules at the location or zone of bending, and downward to 2-3 substantially overlapping layers from such as an initial 4-5 overlapping granule layer configuration associated with an initially formed thermoplastic sheet, will exhibit no substantial loss of visual perception along a non-continuous thermoformed zone.

Applicationally, the article according to the present invention provides a very unique material and method and business model to make countertops, transaction counters, shelves, display stands and shelves, table tops, wall panels, partitions, cabinet doors, thresholds, windowsills, appliance fronts, sinks, vanity tops, modesty panels, and such architectural accoutrements.

The process, material, production, distribution, inventory and distribution costs thereby associated with the present article and processes sacrifice none of its unique advantages in provided a combined and improved decorative and structural benefit to the end user. Further still, the material and necessary processes require only slight modification to existing thermofoil equipment for producing the present article.

Having described my invention, other and additional preferred embodiments will become apparent to those skilled in the art to which it pertains, and without deviating from the scope of the appended claims.

I claim:

1. A thermoformable sheet capable of being applied to a three-dimensional and substantially planar shaped article, comprising:
said sheet having a specified thickness and including at least one layer exhibiting a decoratively effecting material; and
said sheet further exhibiting a thickness no greater than 10% of a least planar dimension associated with the article about which said sheet is secured.

2. The thermoformable sheet as described in claim 1, said sheet having a specified shape and size and further comprising a polyolefin resin.

3. The thermoformable sheet as described in claim 1, said sheet exhibiting a thickness in a range of between 0.008″ to 0.050″.

4. The thermoformable sheet as described in claim 2, further comprising at least one rearward layer applied to said sheet and comprising a thickness in a range of 0.001″ to 0.030″.

5. The thermoformable sheet as described in claim 4, an uppermost layer associated with said sheet exhibiting a specified degree of visibility, ranging from substantially clear to partially translucent, and further comprising at least one type of said decoratively effecting material.

6. The thermoformable sheet as described in claim 4, further comprising at least one decoratively effecting interior layer exhibiting a colored stratum for imparting said decorative effect through a top layer.

7. The thermoformable sheet as described in claim 6, further comprising a plurality of granules entrained within at least one of said upper and interior layers, said granules each having a specified size and being selected from a group exhibiting at least one of metallic, stone and silicate/glass effects.

8. The thermoformable sheet as described in claim 7, the article exhibiting at least one non-planar arcuate extending edge, at least a portion, by weight, of said granules exhibiting a degree of bendability/fragmentation at a region proximate the non-planar edge.

9. The thermoformable sheet as described in claim 7, said decorative granules having a specified shape and size exhibiting a sufficient modulus of elasticity to permit substantially non-segmenting bending during formation of said non-planar edge.

10. The thermoformable sheet as described in claim 4, said upper layer having a specified shape and size and further comprising at least one material selected from a group including a polypropylene and a polyethylene material, said rearward layer further being selected from a least one of an ABS, acrylic and an EVA material.

11. The thermoformable sheet as described in claim 3, exhibiting a specified degree of elasticity and capable of being fabricated in at least one of a rigid stackable sheet and a winded sheet roll for distribution.

12. The thermoformable sheet as described in claim 4, said protective upper layer further comprising at least one of a non-porous acrylic, a polyester and a polyolefin material.

13. The thermoformable sheet as described in claim 6, further comprising said interior layer contributing a degree of structural thickness and opacity such that light transmission is blocked from an angle of 180° relative to a viewable surface of said interior layer.

14. The thermoformable sheet as described in claim 4, said upper layer further comprising a non-dispersing color additive for creating a veined pattern.

15. The thermoformable sheet as described in claim 4, said upper layer further comprising a decorative and index-of-refraction-matching crushed mineral selected from at least one of a silaceous, a calcined, and an oxidized metal material.

16. The thermoformable sheet as described in claim 15, each of said minerals being aqueous based and exhibiting an average mean diameter of less than 3,000 nm.

17. The thermoformable sheet as described in claim 15, said mineral material being entrained into the decorative layer at about 10-40% by weight, in cooperation with additional decorative effect materials including at least one of UV stabilizers, epoxoid binders and stress reliever.

18. A thermoformable sheet capable of being applied to a three-dimensional and substantially planar shaped article, comprising:
said sheet having a specified thickness and including at least one layer exhibiting at least one filler material exhibiting a sufficiently high thermal conductivity to facilitate heat transfer during at least one of forming and curing processes associated with formation of said sheet; and
said sheet further exhibiting a thickness no greater than 10% of a least planar dimension associated with the article about which said sheet is secured.

19. The thermoformable sheet as described in claim 18, said filler material further comprising a polypropylene resin exhibiting a coefficient of linear thermal expansion of 9.0×10⁻⁵ mm/mm/° C.

20. The thermoformable sheet as described in claim 18, further comprising a polyolefin material layer entrained with a mineral and exhibiting a coefficient of linear thermal expansion of less than 9×10⁻⁵ mm/mm/° C.

21. The thermoformable sheet as described in claim 20, further comprising said polyolefin material layer having a selected length, width and thickness with a polymer orientation in both linear and crosswise directions of less than 50%.

22. The thermoformable sheet as described in claim 20, further comprising at least one thermally conductive additive incorporated into said polyolefin material, such mineral featuring a thermal conductivity greater than 0.35.

23. A polymer sheet comprising:
a translucent polymeric matrix formed into said sheet and defining an outer face and a backing surface, said sheet further exhibiting a thickness no greater than 10% of a least planar dimension associated with an article about which said sheet is secured;
said sheet comprising at least one visible and decorative granule component larger than 0.004″ and smaller than 0.6″ in planar size, said granules being present across at least 10% of a total visible surface area of said sheet;
a further decorative component being incorporated within said sheet and selected from at least one of a pigment, a dye, and a dispersion dye;
wherein said first decorative component varies from said second decorative component.

24. The polymer sheet as described in claim 23, said sheet having a specified shape and size and further comprising said granules distributed across more than one individual strata layer associated with a multi-layer structure.

25. The polymer sheet as described in claim 24, said sheet having a specified shape and size and further comprising at least three layers incorporating individual pluralities of said granules collectively visible across at least 20% of a total planar surface area of said sheet.

26. The polymer sheet of claim 23, wherein said decorative granular component includes at least one of a cleaved mineral particulate, a shredded plastic film, and a biopolymer particulate.

27. The polymer sheet as described in claim 23, wherein said further decorative component is embedded within said decorative granular component.

28. The polymer sheet as described in claim 23, wherein said polymeric matrix has a thickness of between 0.01 and 0.10 inches.

29. The polymer sheet as described in claim sheet of claim 24, further comprising a granular coating applied intermediate between said polymeric matrix and a first selected granular entrained strata layer.

30. The polymer sheet as described in claim 23, further comprising a back zone secured to a backing surface associated with said matrix.

31. The polymer sheet as described in claim 30, further comprising an adhesive secured intermediate between said back zone and the article about which the sheet is secured.

32. The polymer sheet as described in claim 31, wherein said adhesive is transparent.

33. The polymer sheet as described in claim 23, further comprising a surface protective layer applied to said viewable surface area of said sheet.
